(19) United States
(12) Patent Application Publication
(10) Pub. No.: US 2017/0132373 A1
(43) Pub. Date: May 11, 2017

(54) SYSTEM AND METHOD FOR COMPILING AND DELIVERING PATIENT INFORMATION AND CLINICAL ASSISTANCE

(71) Applicant: Grand Round Table, Philadelphia, PA (US)

(72) Inventors: Eric Allen KING, Philadelphia, PA (US); John Nevin SCHAEFFER, IV, Philadelphia, PA (US)

(21) Appl. No.: 15/347,141

(22) Filed: Nov. 9, 2016

Related U.S. Application Data
(60) Provisional application No. 62/253,049, filed on Nov. 9, 2015.

(51) Int. Cl. G06F 19/00; G06Q 10/06; G06Q 10/10

(52) U.S. Cl. CPC G06F 19/322; G06F 19/3437; G06F 19/345; G06F 19/325; G06Q 10/109; G06Q 10/06395

(57) ABSTRACT

A system and method for delivering patient information and clinical assistance. Information and related digest reports are delivered at a point in the care team workflow prior to patient arrival. Information is extracted from scheduling data and electronic health record information. Digest reports are generated by the inventive system on a daily or other customizable basis, and profile upcoming patients scheduled to be seen by a healthcare team or team member. Patient information compiled and delivered by the inventive system may include historical data and ongoing patient condition and complaints stored electronically outside of the inventive system. Clinical assistance compiled and delivered to the user may include published clinical guidelines and other clinical recommendations. The system and method of its use have the capacity to aid in the user's adherence to governmental criteria, and in the attainment of value based care goals. These goals may include care coordination, test-tracking, patient follow-up, and other clinical decision support needs that are currently not automated in an efficient manner. Health care providers may save time and money with the system, and are able to to manage an ever increasing burden of patient information more accurately effectively to treat their patients. Customizations of digest reports including specific types of information and data may be generated to accommodate individual healthcare practice group needs as well as value-based care models.

### CROSS-REFERENCE TO RELATED APPLICATIONS

This application claims the priority of U.S. Provisional Patent Application No. 62/253,049, filed on Nov. 9, 2015, which is incorporated herein by reference in its entirety.

### BACKGROUND

Recent government mandates including “Meaningful Use Guidelines” and the “Hi-Tech Act” promote increased electronic storage of health data using Electronic Health Records (EHRs). Although increased transition to electronic storage of patient information and other technology provides significant opportunities to support healthcare care teams, the state of technology has not reached its potential to help health care provider efficiency, improve patient outcomes, and reduce expenditures.

Healthcare care teams may often be unaware of stored, potentially useful patient information, whether because of abundance of data, lack of organization of information stored, or a lack of time in the healthcare team's clinical day to spend reviewing information outside of patient appointments.

### SUMMARY

Care teams currently must spend time looking through charts to read about patients and determine what action items need to be addressed; there is no system or method in the current technology landscape to effectively highlight action items during unstructured time before scheduled patients arrive for orifice visits.

Applicants have recognized and appreciated this deficiency in typical healthcare care team workflow, and developed a system and method of its use to deliver related information about incoming patients during unstructured time before scheduled patients arrive for office visits, to ensure the clinical day runs more smoothly and maximize the value of patient visits.

By compiling and delivering information to healthcare teams earlier in the workflow, Applicant's solution allows for effective discussions among healthcare care teams before the start of clinical hours, more effective preparation for patients visits, and more efficient and effective care during patient visits.

Applicants have recognized and appreciated the effectiveness and efficiency of data usage may be improved by providing support to the healthcare care team prior to the point-of-care so that the care team is more prepared for patient visits.

To this end, some embodiments of the invention are directed toward providing reliable and secure information pertinent to support healthcare care teams in the diagnosis, management, and treatment of patients that are to be seen in the care teams' upcoming work day.

Some embodiments of the present invention are directed to a system of providing information to a user. The inventive system comprises memory storing instructions and a processor coupled to the memory, the processor configured to, based on instructions in the memory, at a predetermined time in a first predetermined time interval, programmatically identify a set of scheduled patients from an external database, booked to visit predetermined healthcare providers over the course of a second, later, predetermined time interval; extract from an electronic health record a snapshot of patient information that is pertinent and timely to individual patients within the set of scheduled patients; compile a digest report comprising information pertinent and timely to each patient within the the set of scheduled patients; generate a push notification which securely links its recipients to the digest report upon system completion of the digest report.

In some embodiments of the inventive system, the digest report compiled by the system comprises a patient profile for each individual patient within the set of patients scheduled.

In some embodiments, the snapshot is directed to the information extracted at a moment in time in the electronic health record.

In some embodiments of the inventive system, the digest report comprises lab results, ordered tests, and changes in the information extracted from the electronic health record made since a patient in the set of scheduled patients last visited a health care provider in a health care practice employing the system.

In some embodiments of the inventive system, the patient profile comprises a list of care gaps. Care gaps comprise information and results that are expected to be present by health care team members but are absent from the electronic health record.

In some embodiments of the invention, programmatic identification of a set of scheduled patients recurs at a predetermined frequency. In an exemplary embodiment, programmatic identification of a set of scheduled patients recurs once each day.

In some embodiments of the inventive system, the patient profile comprises highlighted action items. The highlighted action items may comprise recommendations based upon standards from external data sources.

In some embodiments of the inventive system, the highlighted action items may comprise recommendations to be carried out by the user of the system.

In some embodiments of the inventive system, the user comprises one or more members of a health care provider team.

In some embodiments of the inventive system, the report generated by the system comprises updates and changes on patient statuses compiled from electronically stored data.

In some embodiments, the system identifies care gaps that are applicable to individual patients by sorting externally stored clinical guidelines and quality measures .

In some embodiments of the inventive system, the information compiled and delivered comprises recommended preventive screening measures.

In some embodiments of the system, the report generated by the system comprises recommended additional medical testing.

In some embodiments of the system, users of the system may interactively enter information into the patient profile.

In some embodiments of the system, the push notification is used to coordinate patient care among those care team members granted secure access to the report.

In an exemplary embodiment of the system, the push notification is transmitted to a user in an electronic mail message.

In exemplary embodiments of the system, users may comprise physicians, administrative staff, and nurses.

In some embodiments of the inventive system, the digest report facilitates care management support among the care team members.

In some embodiments of the inventive system, digest report facilitates ‘daily huddles’ among the care team members during which ‘chart prep’ occurs.

In some embodiments of the inventive system, the information compiled and delivered in the digest report facilitates achievement of value based care criteria, comprising patient centered medical homes (PCMHs) and Meaningful Use.

Some embodiments of the invention are directed to a system of delivering information to a user for daily scheduled patients in a report preceding a scheduled clinical care day on which patients arrive for their office visits. The reports may comprise updates and changes among patient statuses and identify care gaps and quality measures.

Some embodiments of the invention are directed to the method comprising accessing at least one system comprising memory storing instructions and a processor coupled to the memory, the processor configured to, based on instructions in the memory, at a predetermined time in a first predetermined time interval, programmatically identify a set of scheduled patients from an external database, booked to visit predetermined healthcare providers over the course of a second, later, predetermined time interval; extract from an electronic health record a snapshot of patient information that is pertinent and timely to individual patients within the set of scheduled patients; compile a digest report comprising information pertinent and timely to each patient within the the set of scheduled patients; generate a push notification which securely links its recipients to the digest report upon system completion of the digest report.

It should be appreciated that all combinations of the foregoing concepts and additional concepts discussed in greater detail below are contemplated as being part of the inventive subject matter disclosed herein. In particular, all combinations of claimed subject matter appearing at the end of this disclosure as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF FIGURES

The accompanying figures are not intended to be drawn to scale. In the drawings:

FIG. 1 is a diagram indicating the typical amount of time primary care physicians spend on patient care and how that amount of time stands to change in situations where the physicians are following standardized guidelines. This demonstrates the lack of time for family physicians to follow clinical guidelines in the current typical workflow without the inventive system.

FIG. 2 is a flow diagram representing the compilation and delivery of digest reports as part of the clinical workflow.

FIG. 3 is a pictorial representation demonstrating how the inventive system compiles information to be used in daily digest reports.

FIG. 4 is an exemplary embodiment of an e-mail alert indicating that a digest report pertinent to upcoming scheduled patients is available and indicating how much pertinent information is available.

FIG. 5 is a schematic of an exemplary embodiment of a daily digest message.

FIG. 6 is an example of of a clinical guideline to be incorporated, in some embodiments of the invention, accessible via a link in the digest report.

FIG. 7 is an example of a high risk diagnosis as displayed by one embodiment of the invention.

FIG. 8 is a representation of a canonical care team interacting with an embodiment of the invention in a “daily patient safety huddle” meeting.

FIG. 9 is a system context diagram of the inventive system clinical assistant.

### DETAILED DESCRIPTION

Thus, there remains an unmet need in the healthcare field for a system that can use data and clinical information that is stored in EHRs in an efficient and helpful way for providers and their supporting medical staff, in order to improve patient care, enhance outcomes, and decrease medical costs. Currently, administrators and providers may manually record information pertinent to an incoming scheduled patient prior to a patient's visit, a process called ‘chart prep’. Thus, a system designed to automatically compile the most pertinent stored information from external sources in order to make patient visits more effective is desirable.

The Applicant recognizes this need and asserts that it can be addressed by the compilation and delivery of pertinent content, at times in the clinical day during which the content is most likely to save care teams time and improve patient outcomes, and notifying the user of the availability of the information, such as by a push notification linked to a digest report. Increased effectiveness may be measured in such ways as diagnostic accuracy, decreased hospital admissions, and various other improved value based outcomes'.

The present disclosure generally relates to a system and method for automatically compiling and providing information on sets of patients to aid care team preparation prior to patient visits, and to promote more efficient and effective patient care and lower expenditures. The information and data used in the inventive system and method may be electronically stored, whether in a local or cloud-based system.

Applicants have recognized and appreciate that there is currently no system for compiling and delivering information pertinent to a set of scheduled patients to healthcare teams prior to scheduled patient appointments. Regulatory requirements for improved information usage have increasingly been created address the technological implementation gap, but care teams still struggle to make use of all the information available to them in a streamlined manner and are often overwhelmed by tasks. Meanwhile patients face unnecessary tests, repeat hospital visits, and deteriorating health.

Both private and public performance-based programs are being established to increase the usage of technology. Through these programs, care teams are incentivized financially to meet quantifiable metrics. However, because of varying and ever changing quality standards, along with increasing demands on care teams' time, often either the care team cannot meet the metrics, or time spent reviewing metrics detracts from time with patients at the point-of-care, resulting potentially in both poorer care and loss of revenue. For instance, if care teams spend time interpreting data during visits, this can cause preventable errors as well as decrease patient satisfaction due to lack of care team attention to patients.

Spending time prior patient visits to manually digest information is time and labor intensive and an improved automated system as that asserted by the Applicant is an unmet need.

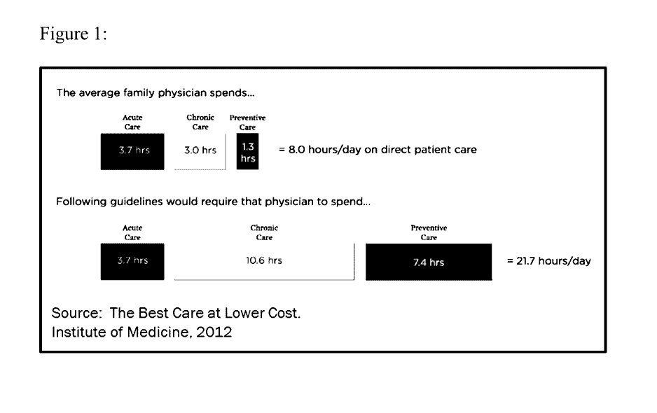

As illustrated in FIG. 1. care teams are short on time even without incorporating guidelines in workflow and having to interpret more guidelines compounds the problem.

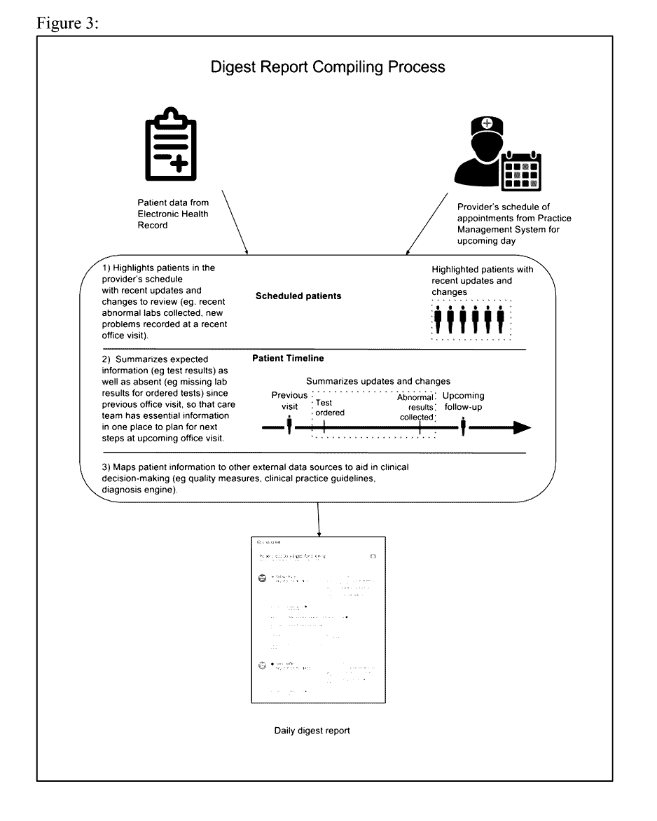

Applicants offer a solution in the form of a system which, in some embodiments, incorporates information from external sources comprising patient data from external electronic health records (EHRs) as well as scheduling information stored electronically. Digest reports in the inventive system are compiled to include highlighted patients with upcoming scheduled visits for which action items or other updates are anticipated; specific recommendations and actions to be taken by a healthcare team in the context of anticipated results and updates; and links users to appropriate external sources of information for more comprehensive user guidance. This compilation process of the digest reports is illustrated in FIG. 3.

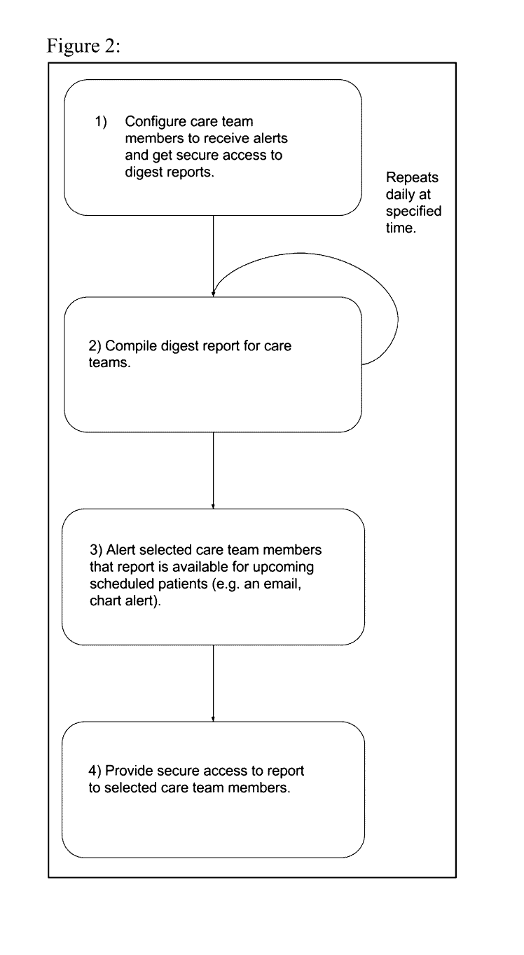

Healthcare teams may, in some embodiments of the inventive system, customize the timing or content of compiled reports or to make other alterations to aid the coordination of patient care by a care team. Configurations may be made by a user to ensure that the report meets a care team's specific needs. In some embodiments, the inventive system automatically repeats each day or at some other specified time interval. A care team member may be delegated in the inventive system to receive securely that information which is most relevant to his role in the coordinated care process. The steps carried out by the system in the compilation and delivery of digest reports as a part of the clinical workflow, in an exemplary embodiment of the inventive system, is illustrated in FIG. 2.

Access to the information generated by the inventive system may be given selectively and securely at administrative discretion to predetermined users, typically healthcare team members that are directly involved in a day's scheduled patients.

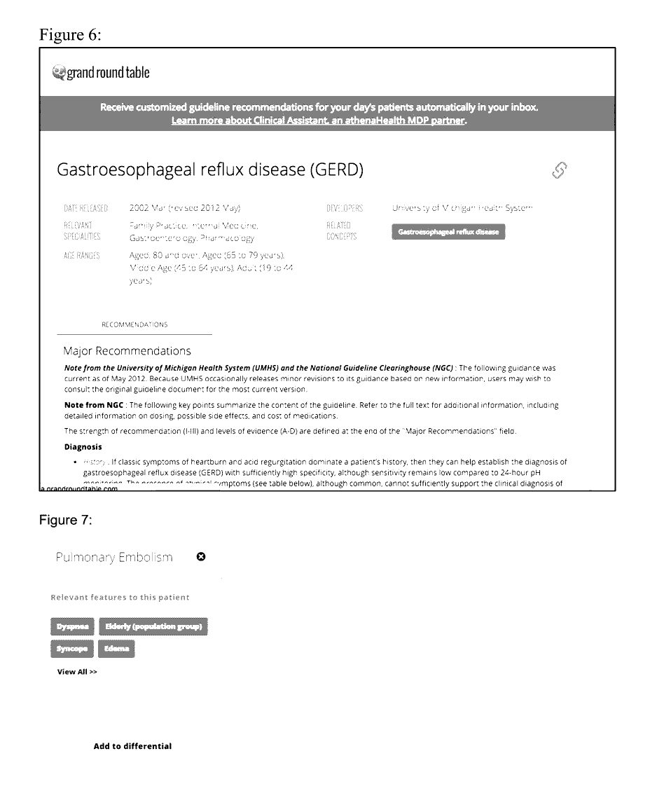

In some embodiments, the inventive system supports clinical decision-making by allowing ready access to pertinent external information, allowing healthcare care teams to leverage the latest clinical guidelines, exemplified in FIG. 6, and other information and research that is relevant to their patients in advance of the point-of-care.

By delivering pertinent information earlier in the workflow process the inventive system serves to meet unmet needs and enhance of clinical workflow. Unlike most current clinical decision support (CDS) solutions that interfere rather than enhance the clinical workflow, the presently disclosed invention has been designed in partnership with primary care teams (PCPs) to save time and improve patient outcomes by making existing, non-billable duties more efficient.

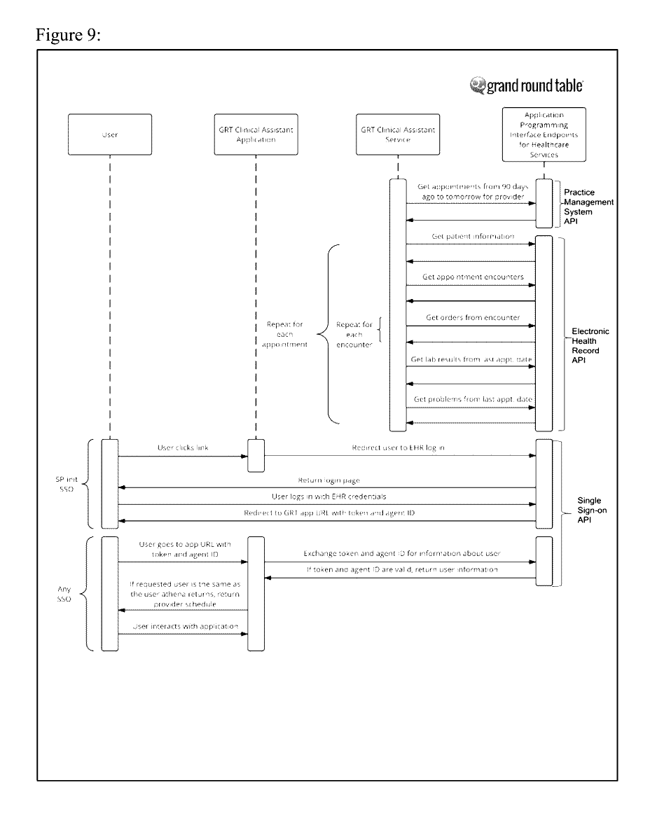

Applicants further recognize that the limited time care teams do have to interact to discuss patients with colleagues is typically early in the day during sessions sometimes called ‘daily huddles’ or ‘chart prep’ periods or ‘grand rounds’ that precede the workflow in a typical care team day. Time for analyzing charts in depth during patient encounters or in between patients is less abundant. Thus, Applicants approached their solution, so that care teams could use it at the point in their day, as shown in FIG. 8, in which they have a chance to speak with colleagues.

In a prototypical embodiment, the solution's cloud-based software is distributed on EHR application stores hosted by EHR vendors (not unlike the Apple Store for the Iphone). For care team groups who elect to turn on the solution, the invention interfaces with the EHR via a secure application programming interface (API), and runs in the background of the EHR automatically processing care teams' scheduled patients, scanning patient clinical data in EHR, and creating a standardized clinical profile, as illustrated in FIG. 9.

Based on this information, in an embodiment of a typical output of the inventive system, an automated message to care teams with a link to a “digest report” summarizing what the care team needs to know about the patients scheduled for the following day.

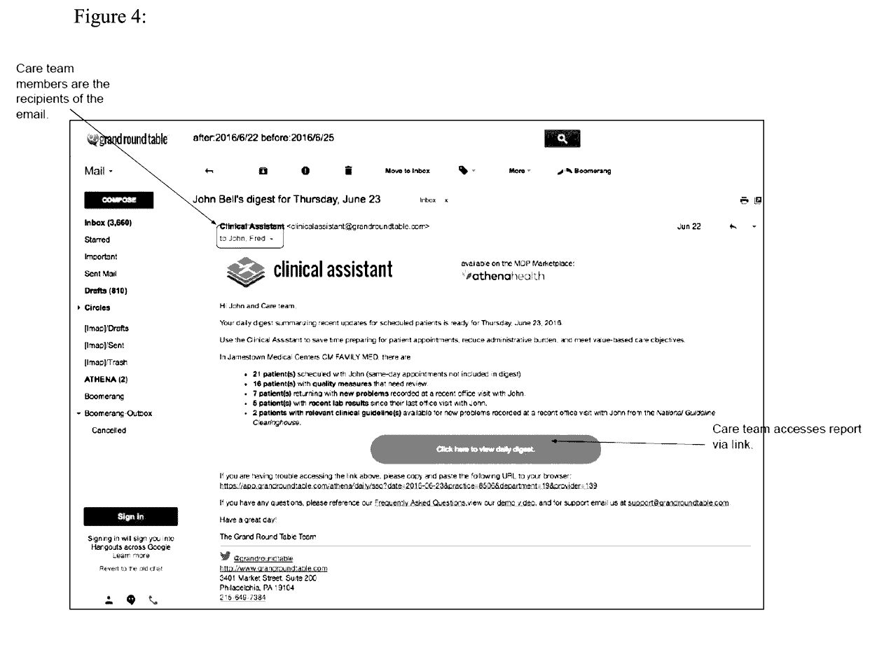

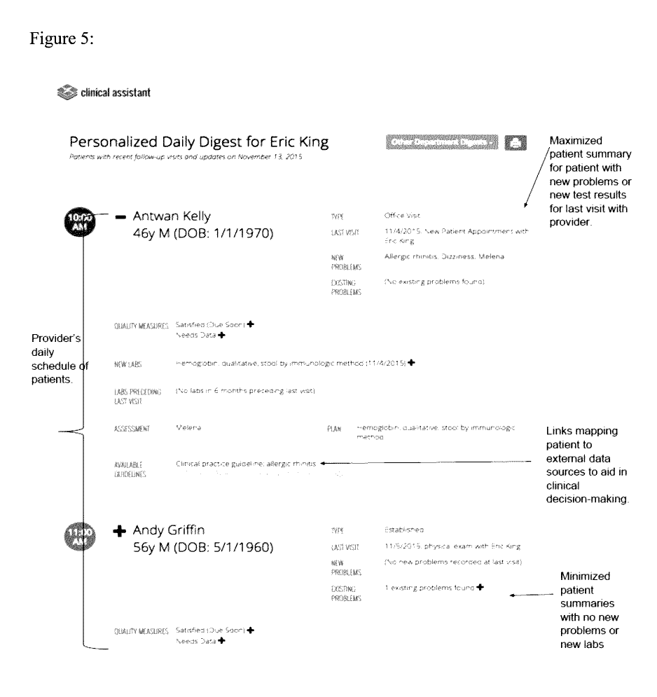

Some embodiments of the inventive system, exemplified in FIG. 5, produce digest reports that denote where decisions on next-steps are needed; review results for all tests ordered during a patient's most recent visit; reference links to relevant, patient-centered clinical guidelines. An example of such a clinical guideline is exemplified in FIG. 6. Users may notifications that a report is prepared for review by an alert, as illustrated in FIG. 4.

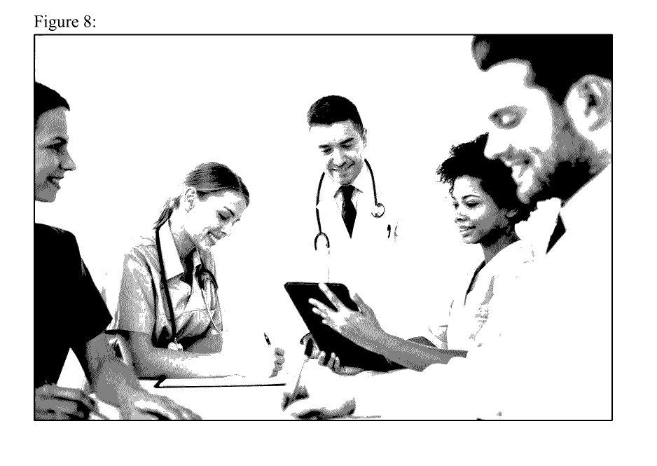

Some embodiments of the inventive system provide action items which may include information to consider on high-risk diagnoses, as illustrated in FIG. 7.

Prior to starting his clinical day, therefore, a typical user of the inventive system not only saves time on non-billable work but also improves patient outcomes by following current standards of care.

The inventive solution will additionally allow compliance with value based care programs such as Meaningful Use and Patient Centered Medical Homes (PCMH). This may allow for collection of financial rewards by the user or his practice group.

In some embodiments, the invention includes one or more storage devices configured to store data related to a plurality patients or one or performanced-based health measures and/or guidelines. The amount and specificity of stored data may vary from patient to patient and among health measure or guidelines.

In some embodiments, a comprehensive electronic digest report is generated prior to the day on which sets of patients are scheduled. Included in the report are pending and completed orders, and all critical diagnostic history for the patients along with reason for the day's appointment. This digest report may be reviewed electronically or printed and reviewed the night before or morning the patients are scheduled to be seen.

Although the inventive system and method of are exemplified in the figures above, it should be appreciated that any number of other components that interact in any suitable way and embodiments of the invention are not limited in this respect. For example, in some embodiments, the content of the messages, exemplified in FIG. 5, may be altered and personalized at administrative or user discretion. Furthermore, some or all of the components in the invention may interact by sharing data, triggering actions to be performed by other components, prevent action from being performed by other components, storing data on behalf of other components , and/or interacting in any other suitable way.

In some embodiments, reports can be specifically customized to the needs of nurses; physicians; administrators; or other users granted access to the system and reports generated by the system.

In accordance with some other embodiments, all patients for the given day are included in the report electronically, but those that are considered most complicated are highlighted and accompanied by more detailed patient information. Those patients with the fewest comorbidities and complications are listed by name, and have a drop-down menu associated with their names, so that the care team may read further information if he chooses.

In some embodiments, the invention may be directly integrated into the user's scheduling system. In other embodiments, the invention may communicate electronically with a scheduling system in order to process the data for the appropriate patients at the correct times.

In some embodiments, reports are generated daily, whereas they may also be generated at other time intervals as determined by a user.

In some embodiments, a user, typically a care team or practice administrator may enter or update stored healthcare data, while conferring such as is illustrated in FIG. 8. In one implementation a user may include a plurality of fields that enable a user to define or edit the types of guidelines or data that he would like displayed.

In some embodiments of the invention, the reports generated may be based upon scheduled outpatient visits.

In other embodiments, the reports generated may be based upon triaged inpatient schedules.

Having thus described several aspects of some embodiments of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that an electronic data management system such as an EHR may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a non-transitory tangible computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “EHR” or “clinical decision support” or ‘practice management system’ are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method of use of the system by a user. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein, unless clearly indicated to the contrary, should be understood to mean “at least one.”

The phrase “and/or,” as used herein, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” shall have its ordinary meaning as used in the field of patent law.

As used herein in, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A system, comprising: memory storing instructions and a processor coupled to the memory, the processor configured to, based on instructions in the memory, at a predetermined time in a first predetermined time interval, programmatically identify from among stored data a set of scheduled patients, booked to visit predetermined healthcare providers over the course of a second, later, predetermined time interval; extract from an electronic health record a snapshot of patient information that is pertinent and timely to individual patients within the set of scheduled patients; compile a digest report comprising information pertinent and timely to each patient within the the set of scheduled patients; generate a push notification which securely links its recipients to the digest report upon system completion of the digest report.

2. The system of claim 1, wherein the digest report compiled by the system comprises a patient profile for each individual patient within the set of patients scheduled.

3. The system of claim 1, wherein the snapshot extracted comprises patient information from a moment in time in the electronic health record.

4. The system of claim 2 wherein a patient profile comprises lab results, ordered tests, and changes in the information stored in the electronic health record since a patient within the set of scheduled patients last visited a health care provider within the health care practice using the system.

5. The system of claim 2 wherein the patient profile comprises a list of care gaps.

6. The system of claim 5, wherein care gaps comprise information that is expected by health care team members but is absent from the electronic health record.

7. The system of claim 1 wherein the programmatic identification of a set of scheduled patients recurs at a predetermined frequency.

8. The system of claim 1 wherein the programmatic identification of a set of scheduled patients recurs once each day.

9. The system of claim 2, wherein the patient profile comprises highlighted action items.

10. The system of claim 9 wherein the highlighted actions items comprise recommendations based upon standards from external data sources.

11. The system of claim 10 wherein the highlighted actions items comprise recommendations directed to users of the system.

12. The system of claim 11, wherein the users comprise one or more members of a health care provider team.

13. The system of claim 2, wherein the digest report generated by the system comprises updates and changes on patient statuses compiled from electronically stored data.

14. The system of claim 5, wherein the system identifies care gaps that are applicable to individual patients from externally stored clinical guidelines and quality measures.

15. The system of claim 2, wherein the information compiled and delivered in the digest report comprises recommended preventive screening measures.

16. The system of claim 1, wherein the digest report generated by the system comprises recommended medical testing.

17. The system of claim 2, wherein users of the system may interactively input information into the patient profile in the system.

18. The system of claim 1, wherein the push notification is used to coordinate patient care among those health care team members granted secure access to the report.

19. The system of claim 1, wherein the push notification is transmitted in an electronic mail message.

20. The method comprising accessing at least one system of claim 1 by a user.
